(19) United States
(12) Patent Application Publication
(10) Pub. No.: US 2013/0101835 A1
(43) Pub. Date: Apr. 25, 2013

(54) CARBON NANOTUBE PASTE COMPOSITION, EMITTER PREPARED USING THE COMPOSITION, AND ELECTRON EMISSION DEVICE INCLUDING THE EMITTER

(71) Applicant: Samsung Electronics Co. Ltd., Suwon-si (KR)

(72) Inventors: Shang-hyeun PARK, Yongin-si (KR); Yong-chul KIM, Seoul (KR)

(73) Assignee: SAMSUNG ELECTRONICS CO. LTD., Suwon-si (KR)

(21) Appl. No.: 13/656,478

(22) Filed: Oct. 19, 2012

(30) Foreign Application Priority Data
Oct. 20, 2011 (KR) 10-2011-0107577

(51) Int. Cl. H01B 1/04; B32B 7/02; B32B 9/00; B82Y 40/00; B82Y 30/00

(52) U.S. Cl. 428/336; 252/511; 252/503; 977/742; 977/752; 977/773

(57) ABSTRACT

A carbon nanotube paste composition including carbon nanotubes, an organopolysiloxane including an alkenyl group, an organohydrogensiloxane including a hydrosilyl group, and a first catalyst effective to catalyze an addition reaction between the alkenyl group and the hydrosilyl group.

### CROSS-REFERENCE TO RELATED APPLICATIONS

This application claims priority to Korean Patent Application No. 10-2011-0107577, filed on Oct. 20, 2011, and all the benefits accruing therefrom under 35 U.S.C. §119, the content of which in its entirety is herein incorporated by reference.

### BACKGROUND

1. Field

The present disclosure relates to a carbon nanotube paste composition, an emitter prepared using the carbon nanotube paste composition, and an electron emission device including the emitter.

2. Description of the Related Art

Carbon nanotube emitters are applicable to all the fields that use field emission. For example, carbon nanotube emitters are used in field emission displays (“FED”), backlight units (“BLU”), lamps, and high-resolution X-ray devices.

Commercially, a carbon nanotube emitter is manufactured by coating a carbon nanotube paste composition including a glass or metal frit on a substrate, such as an electrode, followed by drying, calcining, and activating the coated composition. In this case, the ‘activating’ refers to a process in which an adhesive tape is coated on a carbon nanotube layer after the calcining and then separated from the carbon nanotube layer. However, such carbon nanotube emitters arc during emission. Thus there remains a need for an improved carbon nanotube emitter, and a composition for the preparation thereof.

### SUMMARY

Provided is a carbon nanotube paste composition including carbon nanotubes, an organosilicon compound, and at least one catalyst.

Provided is a method of preparing the carbon nanotube paste composition.

Provided is an emitter prepared using the carbon nanotube paste composition.

Provided is an electron emission device including the emitter.

Additional aspects will be set forth in part in the description which follows and, in part, will be apparent from the description.

According to an aspect, a carbon nanotube paste composition includes: carbon nanotubes, an organopolysiloxane including an alkenyl group, an organohydrogensiloxane including a hydrosilyl group, and a first catalyst effective to catalyze an addition reaction between the alkenyl group and the hydrosilyl group.

The carbon nanotubes may include multi-walled carbon nanotubes.

The carbon nanotube paste composition may further include a second catalyst effective to grow the carbon nanotubes, wherein the amount of the second catalyst is less than 2 weight percent (wt %), based on a total weight of the carbon nanotubes and the second catalyst.

The second catalyst may include at least one selected from the group consisting of cobalt, nickel, iron, and an alloy thereof.

The first catalyst may include platinum.

The carbon nanotube paste composition may further include an inorganic filler having an average particle size of about 50 nanometers (nm) to about 1 micrometer (μm).

The carbon nanotube paste composition may further include an ester dispersion medium.

The organopolysiloxane may have a viscosity of at least 5,000 centistokes (cSt) at a temperature of 25° C.

A total weight of the organopolysiloxane and the organohydrogensiloxane may be in a range of about 200 parts by weight to about 1000 parts by weight, based on a total weight of the carbon nanotubes.

According to another aspect, an emitter includes: a substrate; and a carbon nanotube emitter film disposed on the substrate, the carbon nanotube emitter film including carbon nanotubes, an organosiloxane polymer obtained by an addition reaction between an organopolysiloxane including an alkenyl group and an organohydrogensiloxane including a hydrosilyl group, and a first catalyst effective to catalyze an addition reaction between the alkenyl group and the hydrosilyl group.

The amount of the organosiloxane polymer included in the carbon nanotube emitter film may be 200 parts by weight or more, based on a total weight of the carbon nanotubes.

The amount of the organosiloxane polymer included in the carbon nanotube emitter film may be in a range of about 200 parts by weight to about 1000 parts by weight, based on a total weight of the carbon nanotubes.

An adhesive force of the carbon nanotube emitter film with respect to the substrate may be 110 grams-force or more.

A thickness of the carbon nanotube emitter film may be in a range of about 500 nm to about 20 μm.

A thickness of the carbon nanotube emitter film may be in a range of about 500 nm to about 10 μm.

The carbon nanotube emitter film may have an emission current density of 1 milliampere per square centimeter (mA/cm²) or more at an applied voltage of 2 volts per micrometer (V/μm).

The carbon nanotube emitter film may have an emission current density of 6 mA/cm² at an applied voltage of 2.5 V/μm.

The carbon nanotube emitter film may further include an inorganic filler having an average particle size of about 50 nm to about 1 μm.

According to another aspect, an electron emission device includes the emitter described above.

Also disclosed is a method of manufacturing the carbon nanotube composition described above, the method including combining carbon nanotubes, an organopolysiloxane including an alkenyl group, an organohydrogensiloxane including a hydrosilyl group, and a first catalyst effective to catalyze an addition reaction between the alkenyl group and the hydrosilyl group to manufacture the carbon nanotube paste composition.

### BRIEF DESCRIPTION OF THE DRAWINGS

These and/or other aspects will become apparent and more readily appreciated from the following description of the embodiments, taken in conjunction with the accompanying drawings in which:

FIG. 1 is an optical plan-view micrograph of an embodiment of an emitter prepared using a carbon nanotube paste composition prepared according to Example 1;

FIG. 2 is a sectional-view scanning electron micrograph (“SEM”) of the emitter prepared using a carbon nanotube paste composition prepared according to Example 1; and

FIG. 3 is a graph of current density (milliamperes, mA/cm²) versus electric field (volts per micrometer, V/μm) that illustrates electron emission characteristics of emitters formed using carbon nanotube paste compositions prepared according to Examples 2-1 to 2-4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain features, aspects, and advantages of the present description. As used herein, the term “and/or” includes any and all combinations of one or more of the associated listed items.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. “Or” includes “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkenyl” means a straight or branched chain, monovalent hydrocarbon group having at least one carbon-carbon double bond (e.g., ethenyl (—HC═CH2)).

“Alkoxy” means an alkyl group that is linked via an oxygen (i.e., alkyl-O—), for example methoxy, ethoxy, and sec-butyloxy groups.

“Alkyl” means a straight or branched chain, saturated, monovalent hydrocarbon group (e.g., methyl or hexyl).

“Aryl” means a monovalent group formed by the removal of one hydrogen atom from one or more rings of an arene (e.g., phenyl or napthyl).

“Arylalkylene” group is an aryl group linked via an alkylene moiety. The specified number of carbon atoms (e.g., C7 to C30) means the total number of carbon atoms present in both the aryl and the alkylene moieties. Representative arylalkylene groups include, for example, benzyl, which is a C7 arylalkylene group.

“Cycloalkyl” means a monovalent group having one or more saturated rings in which all ring members are carbon (e.g., cyclopentyl and cyclohexyl).

“Hydrocarbon” means an organic compound having at least one carbon atom and at least one hydrogen atom, wherein one or more of the hydrogen atoms can optionally be substituted by a halogen atom (e.g., CH3F, CHF3 and CF4 are each a hydrocarbon as used herein).

“Substituted” means that the compound or group is substituted with at least one (e.g., 1, 2, 3, or 4) substituent independently selected from the group consisting of a hydroxyl (—OH), a C1-9 alkoxy, a C1-9 haloalkoxy, an oxo (═O), a nitro (—NO2), a cyano (—CN), an amino (—NH2), an azido (—N3), an amidino (—C(═NH)NH2), a hydrazino (—NHNH2), a hydrazono (—C(═NNH2)-), a carbonyl (—C(═O)—), a carbamoyl group (—C(O)NH2), a sulfonyl (—S(═O)2-), a thiol (—SH), a thiocyano (—SCN), a tosyl (CH3C6H4SO2-), a carboxylic acid (—C(═O)OH), a carboxylic C1 to C6 alkyl ester (—C(═O)OR wherein R is a C1 to C6 alkyl group), a carboxylic acid salt (—C(═O)OM) wherein M is an organic or inorganic anion, a sulfonic acid (—SO3H2), a sulfonic mono- or dibasic salt (—SO3MH or —SO3M2 wherein M is an organic or inorganic anion), a phosphoric acid (—PO3H2), a phosphoric acid mono- or dibasic salt (—PO3MH or —PO3M2 wherein M is an organic or inorganic anion), a C1 to C12 alkyl, a C3 to C12 cycloalkyl, a C2 to C12 alkenyl, a C5 to C12 cycloalkenyl, a C2 to C12 alkynyl, a C6 to C12 aryl, a C7 to C13 arylalkylene, a C4 to C12 heterocycloalkyl, and a C3 to C12 heteroaryl instead of hydrogen, provided that the substituted atom's normal valence is not exceeded.

Hereinafter, a carbon nanotube paste composition according to an embodiment, an emitter prepared using the carbon nanotube paste composition, and an electron emission device including the emitter will be disclosed in further detail.

The carbon nanotube paste composition includes carbon nanotubes, an organopolysiloxane including an alkenyl group, an organohydrogensiloxane including a hydrosilyl group, and a first catalyst that is effective to catalyze (e.g., expedites) an addition reaction between the alkenyl group and the hydrosilyl group. In the carbon nanotube paste composition, the organopolysiloxane and the organohydrogensiloxane may be preserved while being physically and/or chemically separated from each other so that they do not contact each other until such contact is desired. According to purpose, when desired, the organopolysiloxane and the organohydrogensiloxane may be mixed so that they contact.

The organopolysiloxane, the organohydrogensiloxane, and an addition product of the organopolysiloxane and the organohydrogensiloxane (also referred to as an organosiloxane polymer below) are collectively referred to as organosilicon compounds. The term “organosilicon compound” used herein refers to an organic compound containing a carbon-silicon (C—Si) bond.

The carbon nanotubes are not limited, and may include, for example, a multi-walled carbon nanotube, a double-walled nanotube, a single-walled carbon nanotube, a carbon nanotube bundle, a metallic carbon nanotube, or a semiconducting carbon nanotube. The term “nanotubes” refers to elongated structures of like dimensions, for example, nanoshafts, nanopillars, nanowires, nanorods, nanoneedles, and their various functionalized and derivatized fibril forms. Carbon nanotubes have at least one minor dimension, for example, a width or a diameter, of about 100 nanometers (“nm”) or less. The nanotubes may have various cross sectional shapes, such as rectangular, polygonal, oval, elliptical, or circular shape. The different types of carbon nanotubes may used alone or in a combination of one or more different types thereof as a mixture. The carbon nanotubes may have any aspect ratio (width/length) effective for electron emission as described below, for example from about 5 to about 1,000,000, or from about 50 to about 500,000, or from about 100 to about 100,000.

A diameter of the carbon nanotubes may be in a range of about 4 nanometers (nm) to about 25 nm, specifically about 6 nm to about 20 nm, more specifically about 8 nm to about 15 nm. If the diameter of the carbon nanotubes is within the range described above, the carbon nanotubes have a high electron emission stability and a long lifetime, and electrical characteristics of the carbon nanotubes are maintained at a high level. Thus, an emitter having a low operating voltage and a high emission current can be provided.

The carbon nanotube paste composition may further include a second catalyst that is effective to catalyze (e.g., expedite) growth of the carbon nanotubes, wherein the amount of the second catalyst is less than about 2 wt %, specifically about 0.01 wt % to about 2 wt %, more specifically about 0.1 wt % to about 1.8 wt %, for example, based on the total weight of the carbon nanotubes and the second catalyst.

The second catalyst may be located within the carbon nanotubes. Because the second catalyst may cause arcing during electron emission and may inhibit the addition reaction between the organopolysiloxane and the organohydrogensiloxane, and because the second catalyst may decrease an adhesive force between a substrate and a carbon nanotube layer, in an embodiment the second catalyst may be omitted.

The second catalyst may include at least one selected from the group consisting of cobalt, nickel, iron, and an alloy thereof.

The carbon nanotube paste composition may additionally include a filler. The filler may compensate for the rigidity of a carbon nanotube layer and may improve the conductivity of the carbon nanotube layer.

A carbon nanotube layer may be formed by disposing the carbon nanotube composition on a substrate. The disposed carbon nanotube composition may be further dried, calcined, and optionally activated to provide the carbon nanotube layer. In an embodiment, the carbon nanotube layer is a layer that is formed by disposing (e.g., printing or coating) the carbon nanotube paste composition on a substrate and drying, calcining, and selectively activating the disposed (e.g., printed or coated) composition.

The substrate may be a glass substrate or an electrode. The glass substrate may comprise at least one selected from the group consisting of a silicate, a borosilicate, and an aluminosilicate.

The filler may not be limited, and may be, for example, selected from the group consisting of a Sn-based conductive compound, such as SnO₂, indium tin oxide (“ITO”), BaTiO₃, nanodiamond, and graphite. In an embodiment, an inorganic filler having an average particle size of about 50 nm to about 1 μm, specifically about 45 nm to about 2 μm, more specifically about 40 nm to about 4 μm may be used.

The amount of the filler may be in a range of about 100 to about 800 parts by weight, based on a total weight of the carbon nanotubes, and in an embodiment the amount of the filler may be in a range of about 200 to about 450 parts by weight, specifically about 250 to about 400 parts by weight, based on a total weight of the carbon nanotubes. If the filler is within the range described above, electron emission of the carbon nanotube layer may be maintained at high level, non-uniformity of the electron emission may be substantially or effectively prevented, and a surface uniformity of the carbon nanotube layer may be increased.

The carbon nanotube paste composition may further include a dispersion medium (for example, an ester dispersion medium). The dispersion medium may disperse a solid material of the carbon nanotube paste composition and provide a suitable viscosity to the carbon nanotube paste composition. The dispersion medium may include a first component that can be removed by stirring (e.g., by evaporation) and a second component that is not removed by stirring and can be removed by calcining. The first component may be a C1 to C10 hydrocarbon having a vapor pressure greater than about 5 kiloPascals (kPa) at 20° C., specifically greater than about 7 kPa at 20° C., more specifically greater than about 9 kPa at 20° C. An embodiment wherein the first component is ethyl acetate is specifically mentioned. The second component may be a C3 to C30 hydrocarbon having a vapor pressure less than about 5 kPa at 20° C., specifically less than about 3 kPa at 20° C., more specifically less than about 2 kPa at 20° C. An embodiment wherein the second compound is terpineol is specifically mentioned. For example, the dispersion medium may include ethyl acetate and terpineol (“TP”).

The amount of the dispersion medium is not limited, and the amount may be selected to be within a range in which a solid material included in the carbon nanotube paste composition is sufficiently dispersed. The amount of the dispersion medium may be in a range of about 500 to about 2000 parts by weight, specifically about 600 to about 1800 parts by weight, more specifically about 700 to about 1600 parts by weight, based on a total weight of the carbon nanotubes. If the amount of the dispersion medium is within the range described above, the solid material may be sufficiently dispersed and a drying time in the course of preparing an emitter may suitable.

The carbon nanotube paste composition may additionally include a vehicle. The vehicle may be used to select the viscosity and printability of the carbon nanotube paste composition. The vehicle may include a polymer component and an organic solvent component. The polymer component may be at least one selected from the group consisting of, but is not limited to, a cellulose resin, such as ethyl cellulose or nitro cellulose; an acryl-based resin, such as polyester acrylate, epoxy acrylate, or urethane acrylate; and a vinyl-based resin. The organic solvent component may be at least one selected from the group consisting of, but is not limited to, n-butyl carbitol acetate (“BCA”), terpineol (“TP”), toluene, texanole, and butyl carbitol (“BC”).

The amount of the organic solvent component may be in a range of about 500 to about 5000 parts by weight, specifically about 600 to about 4500 parts by weight, more specifically about 700 to about 4000 parts by weight, based on a total weight of the polymer component. If the amount of the organic solvent component is within the range described above, the printability or coating property of the carbon nanotube paste composition may be improved. In another embodiment the polymer component may be omitted and the vehicle may consist of the organic solvent.

The amount of the vehicle may be in a range of about 1000 to about 3000 parts by weight, specifically about 1000 to about 3000 parts by weight, more specifically about 1000 to about 3000 parts by weight, based on a total weight of the carbon nanotubes. If the amount of the vehicle is within the range described above, flow properties of the carbon nanotube paste composition may be suitable for printing or coating, and the printability or coating properties of the carbon nanotube paste composition may be improved.

When the organopolysiloxane (which includes a unit of unsaturation such as a vinyl group) and the organohydrogensiloxane are stirred at room temperature (e.g., 25° C.), an addition reaction represented by Reaction Scheme 1 may occur therebetween to form an addition product. Also, due to the addition product, a carbon nanotube layer may be adhered to a substrate. Because the organopolysiloxane and the organohydrogensiloxane are present in a liquid state at room temperature, the carbon nanotube paste composition may be suitably uniform. Also, because the addition product permits omission of solid frit, which is used commercially, arcing during electron emission may be substantially or effectively prevented.

While not wanting to be bound by theory, when the alkenyl group of the organopolysiloxane combines with (e.g., reacts with) a hydrosilyl group of the organohydrogensiloxane (see Reaction Scheme 1), the addition product is produced. This addition product may be referred to as an addition product of the organopolysiloxane including an alkenyl group and the organohydrogensiloxane.

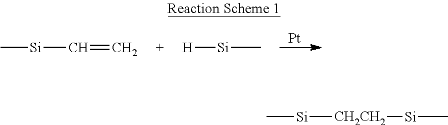

The organopolysiloxane may be a curable precursor, and includes an alkenyl group. The organopolysiloxane may be represented by the following Average compositional formula 1 or 2, and may include two or more monovalent olefinic unsaturated groups per molecule.

R¹ᵢSiO_{(4-i)/}₂ Average compositional formula 1

In Average compositional formula 1, each R¹ is independently a substituted or unsubstituted monovalent hydrocarbon group, wherein at least about 0.15 mole percent (mol %), for example, about 0.2 mol % to about 2.0 mol %, specifically 0.4 mol % to about 1.8 mol % of the R¹ groups comprise an alkenyl group, and i is a positive number that satisfies 1.9≦i≦2.3, for example, 1.95≦i≦2.05, specifically 1.97≦i≦2.03. The term “average compositional formula” refers to a formula determined by generalizing two or more repeating units of the organopolysiloxane, wherein repeating units may be identical to each other (e.g., wherein each R¹ is the same) or may be different from each other but have a commonness (e.g., wherein R¹ is different in two repeating units). Accordingly, the organopolysiloxane may include two or more repeating units each having an identical or a different R¹ and represented by Average compositional formula 1. Also, the wording “wherein at least about 0.15 mole percent (mol %), for example, about 0.2 mol % to about 2.0 mol %, specifically 0.4 mol % to about 1.8 mol % of the R¹ groups comprise an alkenyl group” refers to an embodiment in which the organopolysiloxane includes two or more repeating units each having identical or different R¹ groups, wherein the organopolysiloxane is represented by Average compositional formula 1, and wherein a percentage of the R¹ groups that comprise an alkenyl group, based on the total moles of the R¹ groups, is at least 0.15 mol %.

R¹ may be at least one selected from a C₁ to C₁₀ monovalent hydrocarbon group, for example, a C₁ to C₆ monovalent hydrocarbon group, specifically a C₁ to C₄ monovalent hydrocarbon group. R¹ may be at least one selected from an alkyl group, such as a methyl, ethyl, propyl, butyl, pentyl, hexyl, or cyclohexyl group; an alkenyl group, such as a vinyl, allyl, propenyl, or butenyl group; an aryl group, such as a phenyl, tolyl, or naphthyl group; and an arylalkylene group, such as a benzyl or phenylethyl group. Also, R¹ may be at least one selected from an alkyl group, alkenyl group, aryl group, and an arylalkylene group wherein at least one hydrogen is substituted with a halogen atom to provide a haloalkyl group, such as a chloromethyl, bromoethyl, or trifluoropropyl group, or at least one hydrogen is substituted with a cyano group to provide a cyanoethyl group.

R²ᵢR³ⱼSiO_{(4-i-j)/2} Average compositional formula 2

In Average compositional formula 2, R² is a substituted or unsubstituted C₁ to C₃₀ monovalent hydrocarbon group having at least one unit of unsaturation, R³ is a C₂ to C₆ monovalent olefinic unsaturated group, and i and j are positive numbers that satisfy 0<i<3, 0<j≦3, and 0.1≦i+j≦3. In an embodiment, R² is a substituted or unsubstituted C₁ to C₂₀ monovalent hydrocarbon group having at least one unit of unsaturation, and R³ is a C₃ to C₅ monovalent olefinic unsaturated group, and i and j are positive numbers that satisfy 0.1<i<2.5, 0.1<j≦2.5, and 0.2≦i+j≦2.5.

R² may be at least one selected from an alkyl group, such as a methyl, ethyl, propyl, butyl, pentyl, hexyl, heptyl, oxyl, nonyl, decyl, undecyl, dodecyl, tetradecyl, pentadecyl, hexadecyl, heptadecyl, octadecyl, nonadecyl, eicosyl, henicosyl, docosyl, tricosyl, tetrasyl, or triacontyl group; a cycloalkyl group, such as a cyclobutyl, cyclopentyl, cyclohexyl, or cycloheptyl group; an aryl group, such as a phenyl, tolyl, or napthyl group; an arylalkylene group, such as a benzyl, phenetyl, or β-phenylpropyl group; and a hydrocarbon group that is substituted with a halogen atom (i.e., F, Cl, Br, or I) or another substituent, for example an epoxy group, acryloyloxy group, methacryloyloxy group, glycidoxy group, or carboxyl group, or the like.

R³ may be at least one selected from vinyl, allyl, butenyl, pentenyl, hexenyl, or the like.

The organohydrogensiloxane may be represented by the following Average compositional formula 3, and may include at least three hydrosilyl groups per molecule.

R⁴ₚH_{q}SiO_{4-p-q)/2} Average compositional formula 3

In Average compositional formula 3, R⁴ is a substituted or unsubstituted C₁ to C₃₀ monovalent hydrocarbon group including at least one unit of unsaturation, and p and q are positive numbers that satisfy 0<p<3, 0<q≦3 and 0.1≦p+q≦3, specifically a substituted or unsubstituted C₁ to C₂₀ monovalent hydrocarbon group including at least one unit of unsaturation, and p and q are positive numbers that satisfy 0.1<p<1.5, 0.1<q≦2.5 and 0.2≦p+q≦2.5. Also, the organopolysiloxane and the organohydrogensiloxane may be combined in such a way that a number ratio of the hydrosilyl group to the olefinic unsaturated group is in a range of about 0.5 to about 2, specifically about 0.7 to about 1.8, more specifically about 0.9 to about 1.6.

Examples of R⁴ may be identical or similar to the examples of R².

The organopolysiloxane may have a viscosity of at least 5,000 centistokes (cSt) at a temperature of 25° C., for example, a viscosity of about 10,000 to about 100,000 cSt at a temperature of 25° C., specifically a viscosity of about 20,000 to about 90,000 cSt at a temperature of 25° C.

The amount of the organopolysiloxane may be in a range of about 100 to about 1000 parts by weight, specifically about 200 to about 900 parts by weight, more specifically about 300 to about 800 parts by weight, based on a total weight of the carbon nanotubes. If the amount of the organopolysiloxane is within the range described above, a solid material, such as the carbon nanotubes and the filler, is sufficiently wetted, thereby enhancing an adhesive force of a carbon nanotube layer with a substrate.

The addition product of the organopolysiloxane and the organohydrogensiloxane may comprise an organopolysiloxane moiety which is derived from the organopolysiloxane included in the carbon nanotube paste composition. The amount of the organopolysiloxane moiety may be in a range of about 100 to about 1000 parts by weight, specifically about 200 to about 900 parts by weight, more specifically about 300 to about 800 parts by weight, based on a total weight of the carbon nanotubes.

The organohydrogensiloxane may be represented by Formula 4 below:

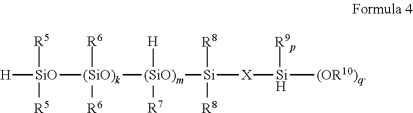

In Formula 4, R⁵, R⁶, R⁷, R⁸, and R⁹ are each independently a substituted or unsubstituted monovalent hydrocarbon group, X is a substituted or unsubstituted bivalent organic group, R¹⁰ is an unsubstituted or alkoxy-substituted alkyl group, k and m are integers that satisfy 0<k≦20 and 0≦m≦20, p is 0, 1 or 2, q is 1, 2, or 3, and p+q=3.

R⁵, R⁵, R⁷, R⁸ and R⁹ may each independently be a C₁ to C₁₀, for example, a C₁ to C₄ monovalent hydrocarbon group. For example, R⁵, R⁶, R⁷, R⁸ and R⁹ may each be independently selected from an alkyl group, such as a methyl, ethyl, propyl, butyl, pentyl, hexyl, or cyclohexyl group; an aryl group, such as a phenyl, tolyl, or naphthyl group; and an arylalkylene group, such as a benzyl or phenylethyl group. Also, R⁵, R⁶, R⁷, R⁸ and R⁹ may each independently be an alkyl group, an aryl group and/or an arylalkylene group wherein at least one hydrogen atom is substituted with a halogen atom or a cyano group, to provide a group such as a chloromethyl, bromoethyl, trifluoropropyl, or a cyanoethyl group.

R¹⁰ may be an unsubstituted or alkoxy-substituted C₁ to C₄ alkyl group. R¹⁰ may be a methyl, ethyl, propyl, butyl, methoxymethyl, methoxyethyl, ethoxymethyl, or ethoxyethyl group.

X may be a C₁ to C₁₀, for example, a C₁ to C₄ bivalent organic group. X may be selected from an alkylene group, such as a methylene, ethylene, propylene, or butylene group; and an arylene group, such as a phenylene group. X may be an alkylene group and/or an arylene group wherein at least one hydrogen atom is substituted with a halogen atom or a cyano group.

The amount of the organohydrogensiloxane in the carbon nanotube paste composition may be in a range of about 1 to about 500 parts by weight, specifically about 2 to about 450 parts by weight, more specifically about 4 to about 400 parts by weight, based on a total weight of the organopolysiloxane. Also, the addition product of the organopolysiloxane and the organohydrogensiloxane may include an organohydrogensiloxane moiety (e.g., a organohydrogensiloxane residue) which is derived from the organohydrogensiloxane. The content of the organohydrogensiloxane moiety in the addition product may be in a range of about 1 to about 500 parts by weight, specifically about 2 to about 450 parts by weight, more specifically about 4 to about 400 parts by weight, based on a total weight of the organopolysiloxane moiety in the addition product. If the amount of the organohydrogensiloxane or the organohydrogensiloxane moiety is within the range described above, a formed carbon nanotube layer or emitter has a strong adhesive force with respect to a substrate and a high rigidity.

A total weight of the organopolysiloxane and the organohydrogensiloxane may be 200 parts by weight or more, for example, in a range of about 200 parts by weight to about 1000 parts by weight, based on a total weight of the carbon nanotubes. Also, a total weight of the organopolysiloxane moiety and the organohydrogensiloxane moiety may be 200 parts by weight or more, for example, in a range of about 200 parts by weight to about 1000 parts by weight, based on a total weight of the carbon nanotubes. If the total weight of the organopolysiloxane or the organopolysiloxane moiety and the organohydrogensiloxane or the organohydrogensiloxane moiety is 200 parts by weight or more, based on a total weight of the carbon nanotubes, an emitter which has a high adhesive force with respect to a substrate and a high electron emission density at the same time may be provided.

The first catalyst expedites (e.g., catalyzes) the addition reaction between the organopolysiloxane and the organohydrogensiloxane.

The amount of the first catalyst in the composition may be in a range of about 1 to about 100 ppm (calculated as platinum metal), for example, about 2 to about 50 ppm (calculated as platinum metal), specifically about 4 to about 35 ppm (calculated as platinum metal), based on a total weight of the organopolysiloxane, the organohydrogensiloxane, and the first catalyst. The amount of the first catalyst in the addition product may be in a range of about 1 to about 100 ppm (calculated as platinum metal), for example, about 2 to about 50 ppm (calculated as platinum metal), specifically about 4 to about 35 ppm (calculated as platinum metal), based on a total weight of the organopolysiloxane moiety, the organohydrogensiloxane moiety, and the first catalyst. If the amount of the first catalyst is within the range described above, a carbon nanotube layer or an emitter which has a high adhesive force with respect to a substrate and is sufficiently rigid may be formed.

The first catalyst may be at least one selected from the group consisting of metallic platinum, a chloroplatinic acid, and a complex of platinum and an unsaturated compound (for example, ethylene, propylene, butadiene, cyclohexene, dicyclooctane, 1,1,3,3-tetramethyl-1,3-divinylsiloxane, or the like).

The carbon nanotube paste composition may additionally include at least one additive selected from the group consisting of a photosensitive resin, a photoinitiator, a leveling agent, a viscosity agent, a resolution agent, a dispersing agent, and an antifoaming agent.

The photosensitive resin may be used in patterning the emitter. Examples of the photosensitive resin include a thermally decomposable acrylate-based monomer, a benzophenone-based monomer, an acetophenone-based monomer, and a thiochixanthone-based monomer. Detailed examples of the photosensitive resin include epoxy acrylate, polyester acrylate, 2,4-diethyloxanthone, and 2,2-dimethoxy-2-phenylacetophenone.

The photoinitiator may initiate crosslinking of the photosensitive resin when the photosensitive resin is exposed to radiation, such as ultra-violet (“UV”), visible, or X-ray radiation. A non-limiting example of the photoinitiator is benzophenone or the like.

The leveling agent may lower a surface tension of surfaces of the carbon nanotubes to improve leveling characteristics of the components included in the carbon nanotube paste composition. If the leveling characteristics are improved, an obtained emitter may have uniform emission and also, because an electric field may be applied uniformly, ultimately the emitter may have a prolonged lifetime.

The viscosity agent, the resolution agent, the dispersing agent, and the antifoaming agent may be selected by one of ordinary skill in the art without undue experimentation and can be a commercially available agent used in the art.

An embodiment provides a carbon nanotube paste composition that is prepared using the method described above and that includes the addition product of the organopolysiloxane and the organohydrogensiloxane.

A viscosity of the carbon nanotube paste composition may be in a range of about 10000 to about 25000 centistokes (cSt), specifically about 12000 to about 23000 cSt, more specifically about 14000 to about 21000 cSt. If the viscosity of the carbon nanotube paste composition is within the range described above, the printability, coating properties, and/or flow properties of the carbon nanotube paste composition may be suitable, and thus, after printing or coating, a desired pattern shape may be easily obtained and workability is suitable.

If an emitter is prepared using the carbon nanotube paste composition having such a structure according to an embodiment, an adhesive force of a carbon nanotube layer with respect to a substrate is easily controllable. Also, due to the absence of frit, which may function as an arcing source, the formed emitter may have a prolonged lifetime and may generate less outgas.

However, and while not wanting to be bound by theory, if as in commercially available emitters, glass frit or metal frit is added to a carbon nanotube paste composition, an adhesive material derived from an adhesive tape remains in the frit during the activation of the emitter (in the course of preparing an emitter), and the adhesive in the frit may cause arcing during electron emission. Also, because glass frit has a relatively large size of 2 μm or more, after calcining, the glass frit may be attached to a surface of a carbon nanotube, such as a tip of a carbon nanotube, causing non-uniformity of the surface and thus arcing. To overcome such disadvantages of the glass frit, Bi-based frit having a size of 1 μm or less may be used. However if Bi-based frit is used, some properties of the carbon nanotubes may deteriorate during calcining. Also, if a metal frit is used, an adhesive force of the carbon nanotubes with respect to a substrate may be reduced. For example, when a nanometal frit is used to improve the adhesive force, the nanometal frit may attach to the surface of a carbon nanotube layer, causing arcing.

A method of preparing the carbon nanotube paste composition, according to an embodiment, may include combining the carbon nanotubes; the filler; the dispersion medium; the vehicle; the organopolysiloxane including an alkenyl group; the organohydrogensiloxane including a hydrosilyl group; and the first catalyst.

The combining may be performed using various methods. For example, the carbon nanotubes, the filler, the dispersion medium, and the organopolysiloxane may be mixed to obtain a first mixture; the organohydrogensiloxane, the first catalyst, the vehicle, and the dispersion medium may be mixed to obtain a second mixture; and then the first mixture may be mixed with the second mixture. In another embodiment, at least the seven components described above may be mixed together at the same time.

The mixing may be performed by using, for example, a homogenizer that rotates at a high speed. The homogenizer may be driven at a rotational speed of about 10,000 to about 25,000 revolutions per minute (RPM) to mill a carbon nanotube agglomerate to obtain carbon nanotube particles having an average largest dimension of 0.1 μon of 20 μm, specifically 0.5 μm to 15 μm, more specifically 1 μm to 10 μm.

The method of preparing the carbon nanotube paste composition may further include milling the mixture obtained from the mixing. The milling may be performed by using, for example, a 3-roll mill. During the milling, a component of the dispersion medium that may be removed by stirring (for example, ethyl acetate) may be removed.

Another embodiment provides an emitter that is prepared by disposing, e.g., printing or coating, the carbon nanotube paste composition on a substrate, followed by drying, calcining, and activating the printed or coated composition. The emitter may include a substrate; and a carbon nanotube emitter film that is disposed on the substrate and includes carbon nanotubes, an organosiloxane polymer obtained by an addition reaction between the organopolysiloxane including an alkenyl group and the organohydrogensiloxane including a hydrosilyl group, and a first catalyst that expedites the addition reaction.

The drying may be performed in a range of about 90° C. to about 130° C., specifically about 100° C. to about 125° C., more specifically about 110° C. to about 120° C.

The calcining may be performed in a range of about 350° C. to about 480° C., specifically about 360° C. to about 470° C., more specifically about 370° C. to about 460° C.

During the drying and calcining, the component of the dispersion medium that is not removed by stirring (for example, terpineol) may be removed.

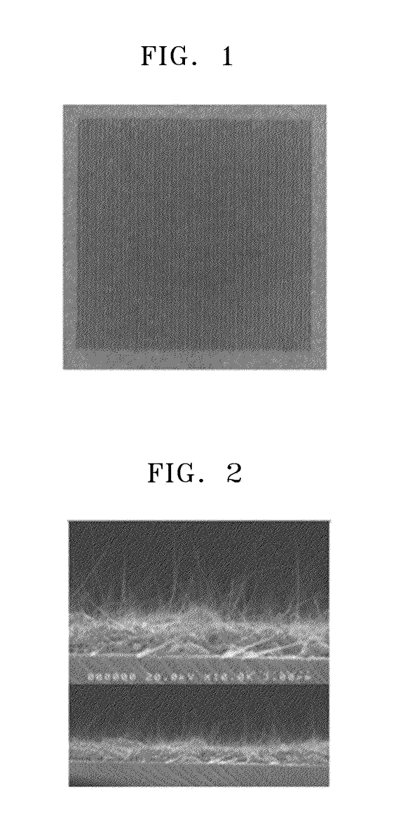

The activating may be performed by attaching an adhesive tape onto a carbon nanotube layer that has been calcined, and separating the adhesive tape from the carbon nanotube layer. Due to the activating, carbon nanotube tips (see FIG. 2) are formed. During the activating, a smaller amount of an adhesive material of the adhesive tape may remain on the carbon nanotube layer than if a frit is present.

The carbon nanotube emitter film may include 200 parts by weight or more, for example, about 200 parts by weight to about 1000 parts by weight, specifically about 300 parts by weight to about 900 parts by weight of the organosiloxane polymer, based on a total weight of the carbon nanotubes. If the amount of the organosiloxane polymer is 200 parts by weight or more, based on a total weight of the carbon nanotubes, a formed emitter may have a strong adhesive force with respect to the substrate and a high electron emission density.

The adhesive force of the carbon nanotube emitter film with respect to the substrate may be about 110 grams-force or more, specifically about 110 grams-force to about 1000 grams-force, more specifically about 125 grams-force to about 800 grams-force.

The thickness of the carbon nanotube emitter film may be in a range of about 500 nm to about 10 μm, for example, about 500 nm to about 20 μm, specifically about 450 nm to about 30 μm.

The carbon nanotube emitter film may have an emission current density of about 1 mA/cm² or more at an applied voltage of 2 V/μm. For example, the carbon nanotube emitter film has an emission current density of about 6 mA/cm² or more at an applied voltage of 2.5 V/μm.

Another embodiment provides an electron emission device including a substrate and an emitter disposed on the substrate.

The electron emission device may be a field emission display (“FED”), a backlight units (“BLU”), a lamp, or a high-resolution X-ray device.

Hereinafter, an exemplary embodiment will be described in further detail. However, the present invention is not limited thereto.

### EXAMPLES

### Example 1

### Preparation Example 1

### Preparation of First Mixture Including Organopolysiloxane

10 grams (g) of carbon nanotubes (MWCNT, JFC Co. Ltd.), 40 g of SnO₂ (Ishihara Co. Ltd., ET500W), 32 g of organopolysiloxane (Shin-Etsu Co. Ltd., X-33-174 A), 140 g of terpineol, and 500 g of ethyl acetate were loaded into a high-speed rotating homogenizer and then mixed at a rotational speed of 3000 revolutions per minute (“RPM”) for 4 minutes to prepare a first mixture.

### Preparation Example 2

### Preparation of Second Mixture Including Organohydrogensiloxane

32 g of organohydrogensiloxane (Shin-Etsu Co. Ltd., X-33-174 B), 200 g of vehicle (ethyl cellulose: n-butylcarbitolacetate (BCA): terpineol=1:4:5, based on weight), and 300 g of ethyl acetate were loaded into a high-speed rotating homogenizer and then mixed at a rotational speed of 3000 RPM for 4 minutes to prepare a second mixture. Herein, the X-33-174 B included a platinum catalyst.

### Preparation Example 3

### Preparation of Carbon Nanotube Paste Composition

The first mixture prepared according to Preparation Example 1 and the second mixture prepared according to Preparation Example 2 were mixed for 12 hours using a mixer. The resulting mixture was passed through a 3-roll mill at a pressure of 0.3 megaPascals (MPa) three times, and then passed through at a pressure of 0.6 MPa four times. A viscosity of the obtained carbon nanotube paste composition was 20000 centistokes (cSt).

### Examples 2-1 to 2-4

Carbon nanotube paste compositions were prepared in the same manner as in Example 1, except that the amounts of the respective components were as is shown in Table 1.

TABLE 1

| | | Example | Example | Example | Example |
|---|---|---|---|---|---|
| | | 2-1 | 2-2 | 2-3 | 2-4 |
| | Component | H1 | H2 | H3 | H4 |
| First | MWCNT (g) | 2.5 | 2.5 | 2.5 | 2.5 |
| mixture | ET500W (g) | 10 | 10 | 10 | 10 |
| | X-33-174 A (g) | 4 | 2 | 5.6 | 8 |
| | Terpineol (g) | 35 | 35 | 35 | 35 |
| | Ethyl acetate | 100 | 100 | 100 | 100 |
| | (g) | | | | |
| Second | X-33-174 B (g) | 4 | 2 | 5.6 | 8 |
| mixture | Vehicle (g) | 50 | 50 | 50 | 50 |
| | Ethyl acetate | 100 | 100 | 100 | 100 |
| | (g) | | | | |

### EVALUATION EXAMPLE

Each of the carbon nanotube paste compositions prepared according to Examples 1 and 2-1 to 2-4 was coated on a glass substrate, dried at a temperature of 110° C. for 10 minutes, and then calcined at a temperature of 450° C. for 30 minutes to form a carbon nanotube film. The carbon nanotube film had a thickness of about 5 μm. Then, an adhesive tape was attached to the carbon nanotube film that was formed through the process described above and then separated therefrom to activate the carbon nanotubes, thereby completing the preparation of an emitter. The activated carbon nanotube film (that is, an emitter film) had a thickness of about 3 μm.

### Evaluation Example 1

Plan and side sectional views of the emitter prepared using the carbon nanotube paste composition prepared according to Example 1 were photographed using an optical microscope and a scanning electron microscope, respectively. Results thereof are shown in FIGS. 1 and 2.

Referring to FIG. 1, it was confirmed that the emitter is uniformly formed on a glass substrate. Also, referring to FIG. 2, it was confirmed that carbon nanotube tips are densely and uniformly formed on the surface of the carbon nanotube layer and are in a direction perpendicular to the surface.

### Evaluation Example 2

The kind and amount of outgas of each of the emitters formed using the carbon nanotube paste compositions prepared according to Examples 2-1 to 2-4 was analyzed by gas chromatography. Results thereof are shown in Table 2. The outgas generation analysis were performed under a vacuum of 20 millimeters of mercury (mmHg).

TABLE 2

| | Example 2-4 | Example 2-3 | Example 2-1 | Example 2-2 |
|---|---|---|---|---|
| | H4 | H3 | H1 | H2 |
| H₂O | 100 | 80 | 91 | 58 |
| CO₂ | 100 | 68 | 86 | 50 |
| Aromatic | 100 | 60 | 45 | 15 |
| compound | | | | |
| Si-based | 100 | 75 | 44 | 3 |
| compound | | | | |
| Total content | 100 | 78 | 49 | 12 |

In Table 2, the amounts of the respective components were calculated based on a total weight of the corresponding component of H4.

Referring to Table 1 and Table 2, it was confirmed that the greater the amount of X-33-174 A (organopolysiloxane) and X-33-174 B (organohydrogensiloxane), the greater the amount of outgas that was generated. Accordingly, it was confirmed that the amount of the generated outgas may be appropriately controlled by selecting the amounts of the organopolysiloxane and the organohydrogensiloxane.

### Evaluation Example 3

An adhesive force of each of the emitters prepared using the carbon nanotube paste compositions prepared according to Examples 2-1 to 2-4 with respect to a glass substrate was measured by using a peel test device, and results thereof are shown in Table 3 below. Conditions for the adhesion measurement are as follows: emitters were peeled off a glass substrate at a 90° angle using a mean moving rate of 900 millimeters per minute (mm/min). Results corresponding to 25 millimeters (mm) out of a total moving distance of 80 mm was used.

TABLE 3

| | | Sample Number | | | | |
|---|---|---|---|---|---|---|
| | | #1 | #2 | #3 | #4 | Average |
| Example 2-4 | H4 | 238.61 | 230.29 | 233.05 | 229.92 | 232.97 |
| Example 2-1 | H1 | 118.34 | 117.67 | 137.50 | 119.87 | 123.35 |
| Example 2-2 | H2 | 100.28 | 95.44 | 110.62 | 87.40 | 98.43 |
| Example 2-3 | H3 | 142.16 | 146.52 | 150.75 | 149.81 | 147.31 |

In Table 3, the unit of the adhesive force is grams-force (gf).

Referring to Table 1 and Table 3, the greater the amount of X-33-174 A (organopolysiloxane) and X-33-174 B (organohydrogensiloxane), the stronger the adhesive force. Accordingly, it was confirmed that an adhesive force of the emitters may be appropriately controlled by selecting the amount of the organopolysiloxane and the organohydrogensiloxane.

### Evaluation Example 4

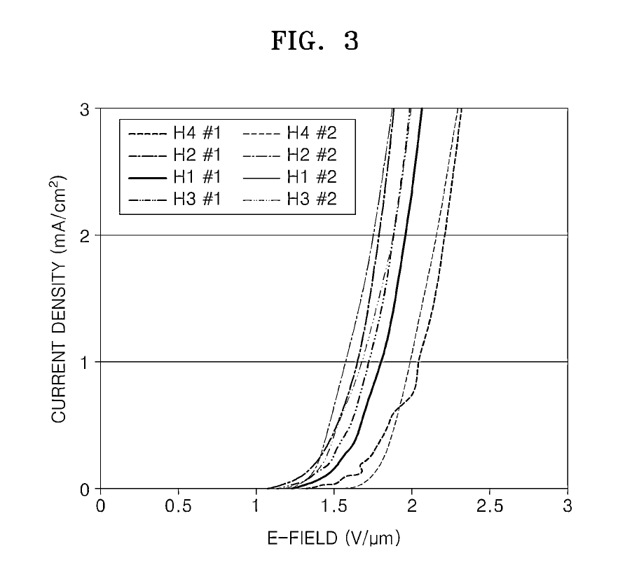

Electron emission characteristics of the emitters prepared using the carbon nanotube paste compositions prepared according to Examples 2-1 to 2-4 were evaluated, and results thereof are shown in FIG. 3. Electron emission characteristics of the emitters were evaluated by measuring current density with respect to electric field (a voltage). In evaluating the electron emission characteristics, indium tin oxide (“ITO”) glass coated with a phosphor was used as an anode and a glass substrate on which a carbon nanotube (“CNT”) paste was pattern-printed was used as a cathode. In this case, an interval between the anode and the cathode was 500 μm. A CNT emitter film had an area of about 1 centimeter (cm)×0.5 cm and a thickness of about 4 μm.

Referring to Table 1 and FIG. 3, it was confirmed that there are amounts of X-33-174 A (organopolysiloxane) and X-33-174 B (organohydrogensiloxane) present to provide unexpectedly improved electron emission characteristics. Also, the CNT emitter film showed a high current density of about 1 mA/cm² or more at an applied voltage of 2 V/μm or about 6 mA/cm² or more at an applied voltage of 2.5 V/μm.

As described above, regarding the carbon nanotube paste compositions according to the above embodiment, an adhesive force of a carbon nanotube layer (that is, an emitter film) with respect to a substrate may be controlled by selecting the total amount and ratio of organopolysiloxane including an alkenyl group and organohydrogensiloxane.

Also, unlike a commercially available carbon nanotube paste composition, the carbon nanotube paste composition uses a liquid-phase organosiloxane instead of a solid-phase inorganic binder, such as glass frit, and thus uniformly mixing is possible and thereby a uniform composition may be obtained.

Accordingly, the emitter prepared using the carbon nanotube paste composition may have uniform emission characteristics and excellent electron emission characteristics. Also, due to the absence of frit, which may function as an arcing source in the emitter, the emitter may have a prolonged lifetime. Also, when the emitter is applied to a vacuum device, less outgas is generated than in commercially available materials.

It should be understood that the exemplary embodiments described herein should be considered in a descriptive sense only and not for purposes of limitation. Descriptions of features, advantages, or aspects within each embodiment should be considered as available for other similar features, advantages, or aspects in other embodiments.

What is claimed is:

1. A carbon nanotube paste composition comprising:
carbon nanotubes,
an organopolysiloxane comprising an alkenyl group,
an organohydrogensiloxane comprising a hydrosilyl group, and
a first catalyst effective to catalyze an addition reaction between the alkenyl group and the hydrosilyl group.

2. The carbon nanotube paste composition of claim 1, wherein the carbon nanotubes comprise multi-walled carbon nanotubes.

3. The carbon nanotube paste composition of claim 1, wherein the carbon nanotube paste composition further comprises a second catalyst effective to grow the carbon nanotubes, wherein an amount of the second catalyst is less than 2 weight percent, based on a total weight of the carbon nanotubes and the second catalyst.

4. The carbon nanotube paste composition of claim 1, further comprising a second catalyst, wherein the second catalyst comprises at least one selected from the group consisting of cobalt, nickel, iron, and an alloy thereof.

5. The carbon nanotube paste composition of claim 1, wherein the first catalyst comprises platinum.

6. The carbon nanotube paste composition of claim 1, wherein the carbon nanotube paste composition further comprises an inorganic filler having an average particle size of about 50 nanometers to about 1 micrometers.

7. The carbon nanotube paste composition of claim 1, wherein the carbon nanotube paste composition further comprises an ester dispersion medium.

8. The carbon nanotube paste composition of claim 1, wherein the organopolysiloxane has a viscosity of at least 5,000 centistokes at a temperature of 25 degrees centigrade.

9. The carbon nanotube paste composition of claim 1, wherein a total weight of the organopolysiloxane and the organohydrogensiloxane is in a range of about 200 parts by weight to about 1000 parts by weight, based on a total weight of the carbon nanotubes.

10. An emitter comprising:
a substrate; and
a carbon nanotube emitter film disposed on the substrate, the carbon nanotube emitter film comprising
carbon nanotubes,
an organosiloxane polymer obtained by an addition reaction between an organopolysiloxane including an alkenyl group and an organohydrogensiloxane including a hydrosilyl group, and
a first catalyst effective to catalyze an addition reaction between the alkenyl group and the hydrosilyl group.

11. The emitter of claim 10, wherein an amount of the organosiloxane polymer included in the carbon nanotube emitter film is 200 parts by weight or more, based on a total weight of the carbon nanotubes.

12. The emitter of claim 11, wherein the amount of the organosiloxane polymer included in the carbon nanotube emitter film is in a range of about 200 parts by weight to about 1000 parts by weight, based on a total weight of the carbon nanotubes.

13. The emitter of claim 10, wherein an adhesive force of the carbon nanotube emitter film with respect to the substrate is 110 grams-force or more.

14. The emitter of claim 10, wherein a thickness of the carbon nanotube emitter film is in a range of about 500 nanometers to about 10 micrometers.

15. The emitter of claim 14, wherein a thickness of the carbon nanotube emitter film is in a range of about 500 nanometers to about 20 micrometers.

16. The emitter of claim 10, wherein the carbon nanotube emitter film has an emission current density of 1 milliamperes per square centimeter or more at an applied voltage of 2 volts per micrometer.

17. The emitter of claim 10, wherein the carbon nanotube emitter film has an emission current density of 6 milliamperes per square millimeter at an applied voltage of 2.5 volts per micrometer.

18. The emitter of claim 10, wherein the carbon nanotube emitter film further comprises an inorganic filler having an average particle size of about 50 nanometers to about 1 micrometer.

19. An electron emission device comprising the emitter of claim 10.

20. A method of manufacturing the carbon nanotube paste composition of claim 1, the method comprising:
combining carbon nanotubes, an organopolysiloxane comprising an alkenyl group, an organohydrogensiloxane comprising a hydrosilyl group, and a first catalyst effective to catalyze an addition reaction between the alkenyl group and the hydrosilyl group to manufacture the carbon nanotube paste composition.
